(19) United States
(12) Patent Application Publication
(10) Pub. No.: US 2004/0177733 A1
(43) Pub. Date: Sep. 16, 2004

(54) Composite socket wrench

(76) Inventor: David Peters, West Chester, OH (US)

Correspondence Address: WOOD, HERRON & EVANS, LLP, 2700 CAREW TOWER, 441 VINE STREET, CINCINNATI, OH, 45202, US

(21) Appl. No.: 10/791,508

(22) Filed: Mar. 2, 2004

Related U.S. Application Data
(60) Provisional application No. 60/453,808, filed on Mar. 11, 2003.

(51) Int. Cl. B25G 1/08

(52) U.S. Cl. 81/490

(57) ABSTRACT

A composite socket wrench is formed from a thermoplastic polymer, such as glass filled nylon 6. The wrench includes a handle preferably hollow with a solid neck portion and an annular head. The wrench is injection molded with an annular metal insert in the head portion. A ratchet mechanism fits within the insert. Preferably a set of sockets are included in the handle portion.

### BACKGROUND OF THE INVENTION

Socket wrenches, also referred to as ratchet wrenches, have a drive which rotates a socket which engages a nut or bolthead causing it to rotate. These are generally made of metal, i.e., iron, aluminum or steel. Further, a plurality of sockets are used, each socket having a different sized opening to fit a different size nut or bolt. The drive for all the sockets is the same. Generally the sockets are stored separate from the wrench.

However, there are many different types of socket wrenches which have been used which hold or house a plurality of sockets. None of these are particularly efficient. Either they lose a great deal of torque in the design of the overall wrench or the location of the sockets is very inconvenient.

For example, in Martinmaas, U.S. Pat. Nos. 4,253,356 and 4,352,306 disclose a socket set in which the sockets are held in an open handle of the wrench. When one grasps the wrench, they actually grasp the sockets which is particularly uncomfortable and would prevent one from applying a great deal of torque. Lin, U.S. Pat. No. 4,627,315 discloses a wrench socket combination in which the sockets are held in a tray. However the sockets are held in an upright position making the size of the handle very awkward and thus difficult to use.

Peters, U.S. Pat. No. 6,401,577 discloses a metal socket set where the sockets are stored in the handle.

### SUMMARY OF THE INVENTION

The present invention is premised on the realization that a socket wrench can be formed from a composite material. In a preferred embodiment the socket wrench has a hollow handle which is adapted to hold a plurality of sockets laying on their side and supported in a tray which is adapted to fit within the handle. A cap is placed at the end of the handle to hold the tray and the sockets in position. The structure of the wrench allows it to be formed from a thermoplastic.

The objects and advantages of the present invention will be further appreciated in light of the following detailed description and drawings in which:

### BRIEF DESCRIPTION OF DRAWINGS

FIG. 1 is a perspective view of the present invention;

FIG. 2 is a cross-sectional view of the present invention partially in elevation taken at lines 2-2 of FIG. 1;

FIG. 3 is a perspective view broken away showing the cap detached from the handle; and

FIG. 4 is an exploded view broken away of the head of the wrench.

### DETAILED DESCRIPTION

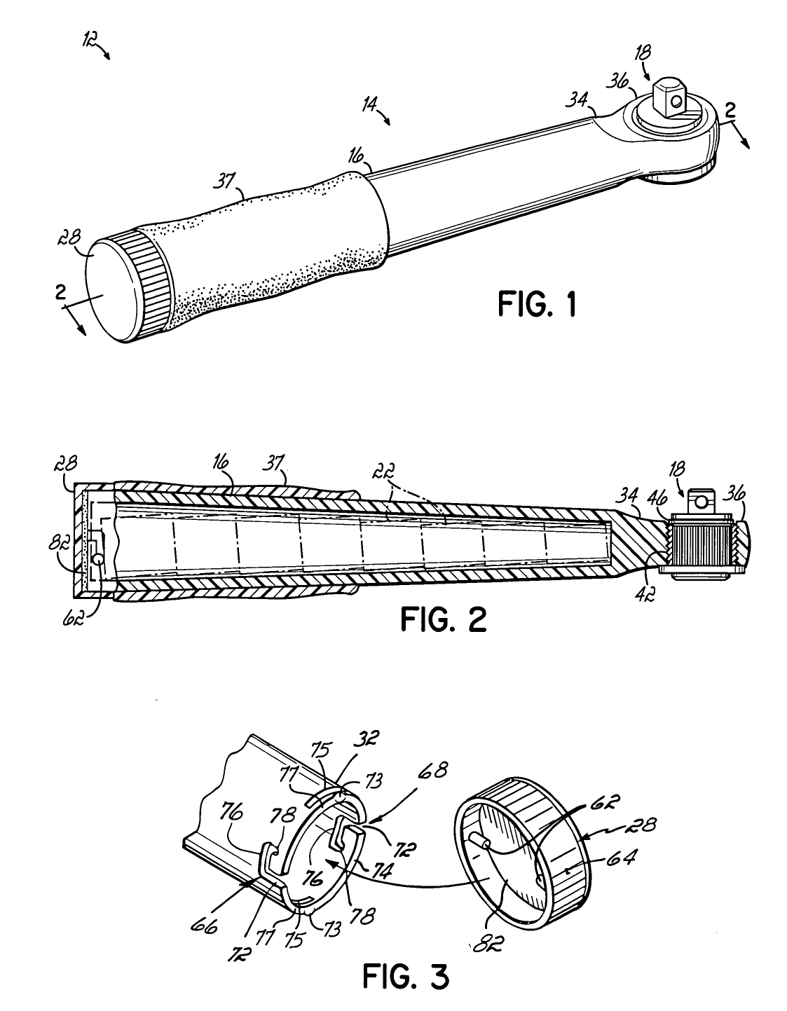

As shown more particularly in FIG. 1, a socket wrench set 12 includes a socket wrench 14 which has a handle 16 and a ratchet drive mechanism 18. The set also includes a plurality of different sockets 22 which are stored together in a plastic tray (not shown) which fits within the handle 16. The sockets are maintained in the handle 16 by a cap 28 covering an open end 32 of the socket handle 16.

More particularly as shown in the present invention, the hollow tapered handle 16 of socket wrench 14 terminates in a solid neck 34 which connects to the annular head 36 of the socket wrench 14.

Cap 28 is specially designed to be easily removed from the handle 16. It includes pins 62 which extend from opposite sides of cap 28. Pins 62 are adapted to fit within first and second L-shaped channels 66 and 68 which are formed through the handle 16.

The L-shaped channels 66 include axially extended portions 72 which start at the distal edge 74 of end 32 and extend to a crossing portion 76 and terminates in an upwardly extended or detent portion 78. As shown, the cap is placed over the end of handle 16 so that the pins 62 fit into the axial portions 72 until pins 62 reach the crossing portions 76. Further rotation of the cap moves pins 62 to detent portions 78 of channels 66 and 68.

The plastic handle includes cut out portions 75 slightly below edge 74 of handle 16. This allows the edge portions 77 immediately above cut out portions 75 to flex. Edge portions 77 each include a raised nub 73. When the cap is attached to the handle with pins 62 in channels 66 and 68, these nubs 73 press against back wall 82 and hold the pins 62 in the detent portions 78 of channels 66 and 68 preventing an unintentional separation of the cap from the handle.

The socket wrench 14 including its handle 16, neck 34 and head 36 are formed by injection molding and specifically utilizing a high strength thermoplastic material such as nylon which may or may not be filled with reinforcing fibers such as carbon fibers, glass fibers, metal fibers and the like. Nylon 6 with 30% glass fibers is preferred.

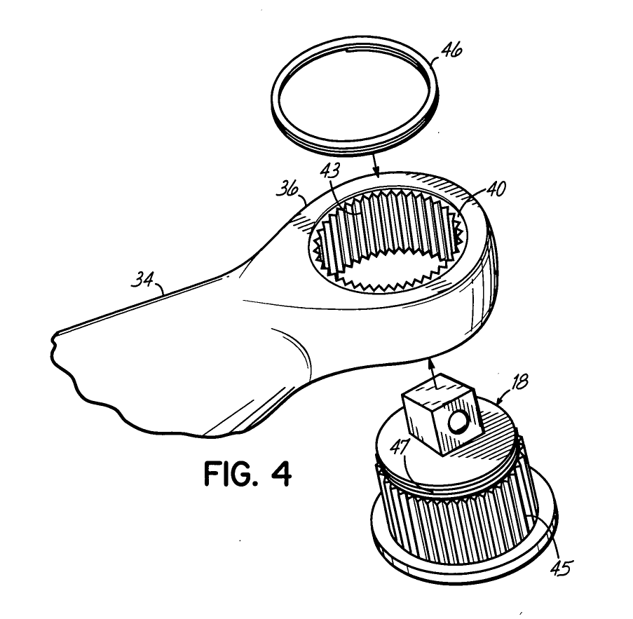

As shown in FIG. 4, the wrench is injection molded with an annular insert 40 which has a gnarled exterior surface 42 which engages the annular head portion 36 of wrench 14. The insert 40 has an internal surface 43 having a plurality of ridges. A ratcheting mechanism 18 is inserted into the insert 40. The ratcheting mechanism 18 has a plurality of outwardly extended ridges 45 which interengage in the inwardly extended ridges in the annular insert 40. An expandable O-ring 46 is then inserted into a channel 47 in the ratcheting mechanism which in turn holds it in position on head portion 36.

As shown in the cross-section of FIG. 2, the wrench of the present invention includes a hollow handle 16, a solid neck portion 34 which leads to the annular head portion 36. The solid neck portion provides the requisite strength to withstand the torque applied during use whereas the hollow handle provides an adequate grip and is subjected to significantly less torque. Because of its shape, it can be hollow and hold sockets 22. Extending around the exterior of the handle is a rubber grip 37.

Thus, the present invention provides a very unique way to hold the sockets within the socket wrench. But most importantly it does not cause an extreme deviation of the shape of the socket wrench. Thus it basically has the same feel as a normal socket wrench because of the shape of the socket handle, i.e., tubular. This design in turn allows the wrench to be formed from plastic and retain its required performance characteristics.

This has been a description of the present invention along with the preferred method of practicing the present invention. However, the invention itself should only be defined by the appended claims wherein

I claim:

1. A socket wrench comprising:
a handle, a solid neck portion and an annular head;
a ratchet mechanism in said annular head;
wherein said handle, said neck portion and said annular head are formed from a polymer.

2. The wrench claimed in claim 1 wherein said polymer is nylon 6.

3. The wrench claimed in claim 2 wherein said nylon is glass fiber reinforced nylon 6.

4. The wrench claimed in claim 3 wherein said handle is hollow.

5. The wrench claimed in claim 4 wherein said wrench includes a plurality of sockets located in said hollow handle and further comprises a removable cap at the end of said handle.

6. A socket wrench comprising:
a hollow handle storing a plurality of sockets;
a solid neck extending between said handle and an annular head;
a ratchet mechanism molded into said head;
wherein said handle; said neck, and said annular head are formed from a polymer.
